(19) United States
(12) Patent Application Publication
(10) Pub. No.: US 2014/0232757 A1
(43) Pub. Date: Aug. 21, 2014

(54) DISPLAY DEVICE AND ELECTRONIC APPARATUS

(71) Applicant: Sony Corporation, Tokyo (JP)

(72) Inventor: Yuji NAKAHATA, Tokyo (JP)

(73) Assignee: Sony Corporation, Tokyo (JP)

(21) Appl. No.: 14/175,294

(22) Filed: Feb. 7, 2014

(30) Foreign Application Priority Data
Feb. 15, 2013 (JP) 2013-027382

(51) Int. Cl. G09G 3/20

(52) U.S. Cl. CPC G09G 3/2003
USPC 345/690

(57) ABSTRACT

A display device includes: a plurality of pixels that are two-dimensionally arranged, and each including two or more sub-pixels configured to emit respective color light beams that are different in color from one another; and a drive section configured to perform a display drive of the pixels. The two or more sub-pixels include a first sub-pixel and a second sub-pixel each configured to emit the color light beam that contains a luminance component as a primary component, and the first sub-pixel and the second sub-pixel are disposed to have a symmetry property with respect to a center of a unit region that is formed by one or more pixels of the pixels, or with respect to an axis that passes through the center.

### CROSS REFERENCES TO RELATED APPLICATIONS

The present application claims priority to Japanese Priority Patent Application JP 2013-027382 filed in the Japan Patent Office on Feb. 15, 2013, the entire content of which is hereby incorporated by reference.

### BACKGROUND

The present disclosure relates to a display device that displays a color image and to an electronic apparatus including the same.

In recent years, in display devices such as an LCD (Liquid Crystal Display) and an organic EL (Electro Luminescence) display, a pixel array that includes a high luminance pixel, such as a W (white) pixel, in addition to color pixels of R (red), G (green), and B (blue) is used in order to improve transmittance (luminance) (for example, see Japanese Unexamined Patent Application Publication No. 2008-287068).

### SUMMARY

However, there is an issue that, in a display device using a high luminance pixel as described above, a so-called dark line (or a bright line) occurs in a display image, and display image quality deteriorates.

It is desirable to provide a display device capable of suppressing deterioration in display image quality while improving luminance, and an electronic apparatus including the same.

A display device according to an embodiment of the present disclosure includes: a plurality of pixels that are two-dimensionally arranged, and each including two or more sub-pixels configured to emit respective color light beams that are different in color from one another; and a drive section configured to perform a display drive of the pixels. The two or more sub-pixels include a first sub-pixel and a second sub-pixel each configured to emit the color light beam that contains a luminance component as a primary component, and the first sub-pixel and the second sub-pixel are disposed to have a symmetry property with respect to a center of a unit region that is formed by one or more pixels of the pixels, or with respect to an axis that passes through the center.

An electronic apparatus according to an embodiment of the present disclosure is provided with a display device. The display device includes: a plurality of pixels that are two-dimensionally arranged, and each including two or more sub-pixels configured to emit respective color light beams that are different in color from one another; and a drive section configured to perform a display drive of the pixels. The two or more sub-pixels include a first sub-pixel and a second sub-pixel each configured to emit the color light beam that contains a luminance component as a primary component, and the first sub-pixel and the second sub-pixel are disposed to have a symmetry property with respect to a center of a unit region that is formed by one or more pixels of the pixels, or with respect to an axis that passes through the center.

In the display device and the electronic apparatus according to the above-described respective embodiments of the present disclosure, the two or more sub-pixels, configured to emit the respective color light beams that are different in color from one another, include the first sub-pixel and the second sub-pixel each configured to emit the color light beam that contains the luminance component as a primary component. The first sub-pixel and the second sub-pixel are disposed to have the symmetry property with respect to the center of a unit region that is formed by one or more pixels of the pixels, or with respect to the axis that passes through the center. Thereby, an interval between the first sub-pixel and the second sub-pixel becomes substantially constant between pixel rows (or between pixel columns) that are adjacent to each other. As a result, generation of a dark line or a bright line in a displayed image is suppressed.

According to the display device and the electronic apparatus of the above-described respective embodiments of the present disclosure, each of the pixels includes two or more sub-pixels that are configured to emit the respective color light beams that are different in color from one another, and the first sub-pixel and the second sub-pixel, each configured to emit the color light beam that contains the luminance component as a primary component, in the two or more sub-pixels are disposed to have the symmetry property with respect to the center of a unit region that is formed by one or more pixels of the pixels, or with respect to the axis that passes through the center. Thereby, even when the first sub-pixel and the second sub-pixel each including the luminance component as a primary component are arranged in one pixel, generation of a dark line or a bright line in a displayed image is suppressed. Therefore, it is possible to suppress deterioration in display image quality while improving the luminance.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating overall configuration of a display device according to an embodiment of the present disclosure.

FIG. 2 is a schematic plan view illustrating an example of a pixel array of the display device illustrated in FIG. 1.

FIG. 3 is a schematic plan view for describing an arrangement example of sub-pixels in one pixel illustrated in FIG. 2.

FIG. 4 is a schematic plan view illustrating an example of a pixel array according to a comparative example.

FIG. 5 is a schematic view illustrating each part of a pixel column in which a G pixel is driven to emit light and a pixel column in which a W pixel is driven to emit light in the pixel array illustrated in FIG. 4.

FIG. 6 is a schematic view illustrating each part of a pixel column in which a G pixel is driven to emit light and a pixel column in which a W pixel is driven to emit light in the pixel array illustrated in FIG. 2.

FIG. 7 is a schematic view illustrating each part of a pixel row in which a G pixel is driven to emit light and a pixel row in which a W pixel is driven to emit light in the pixel array illustrated in FIG. 2.

FIG. 8A is a schematic view illustrating an example of a light emission drive of R, G, and B pixels (sub-pixels) in the case of performing a display drive on a pixel basis.

FIG. 8B is a schematic view illustrating an example of a light emission drive of R, G, and B pixels (sub-pixels) in the case of performing a display drive based on sub-pixel rendering.

FIG. 9A is a schematic view illustrating an example of a light emission drive of R, G, B, and W pixels (sub-pixels) in the case of performing the display drive on a pixel basis in the pixel array illustrated in FIG. 4.

FIG. 9B is a schematic view for describing a disadvantage in the case of performing the display drive based on the sub-pixel rendering in the pixel array illustrated in FIG. 4.

FIG. 10A is a schematic view illustrating an example of a light emission drive of R, G, B, and W pixels (sub-pixels) in the case of performing the display drive on a pixel basis in the pixel array illustrated in FIG. 2.

FIG. 10B is a schematic view illustrating an example of a light emission drive of R, G, B, and W pixels (sub-pixels) in the case of performing the display drive based on the sub-pixel rendering in the pixel array illustrated in FIG. 2.

FIG. 11 is a schematic plan view illustrating an example of a pixel array according to modification example 1.

FIG. 12 is a schematic plan view illustrating an example of a pixel array according to modification example 2.

FIG. 13 is a schematic plan view illustrating an example of a pixel array according to modification example 3.

FIG. 14 is a schematic plan view illustrating an example of a pixel array according to modification example 4.

FIG. 15 is a schematic view illustrating a configuration example of a three-dimensional image display device of a pattern retarder type.

FIG. 16 is a schematic view illustrating an example of a display drive using the pixel array illustrated in FIG. 14.

FIG. 17 is a schematic plan view illustrating an example of a pixel array according to modification example 5.

FIG. 18 is a schematic plan view illustrating an example of a pixel array according to modification example 6.

FIG. 19A is a perspective view illustrating a configuration of a smartphone according to application example 1.

FIG. 19B is a perspective view illustrating a configuration of the smartphone according to the application example 1.

FIG. 20 is a perspective view illustrating a configuration of a television set according to application example 2.

FIG. 21A is a perspective view illustrating a configuration of a digital still camera according to application example 3.

FIG. 21B is a perspective view illustrating a configuration of the digital still camera according to the application example 3.

FIG. 22 is a perspective view illustrating an appearance of a personal computer according to application example 4.

FIG. 23 is a perspective view illustrating an appearance of a video camera according to application example 5.

FIGS. 24A to 24G are each a plan view illustrating a configuration of a mobile phone according to application example 6.

### DETAILED DESCRIPTION

Hereinafter, some embodiments of the present disclosure are described in detail with reference to the accompanying drawings. The description will be given in the following order.

1. Embodiment (Example of a pixel array in which G and W pixels have a symmetry property in a pixel and form a line in a stripe)

2. Modification Example 1 (Another example of a side-by-side arrangement of G and W pixels)

3. Modification Example 2 (Example where G and W pixels are each disposed as a line in the stripe)

4. Modification Example 3 (Example where a white pixel is disposed in a rectangular region and a green pixel is disposed around the while pixel)

5. Modification Example 4 (Example of a pixel array preferable in performing display of a three-dimensional image on the basis of a pattern retarder scheme)

6. Modification Example 5 (Example where R, G, and B pixels are disposed around a W pixel)

7. Modification Example 6 (Example where G and W pixels have a symmetry property in a unit region that includes two pixels adjacent to each other)

### Embodiment

[Configuration]

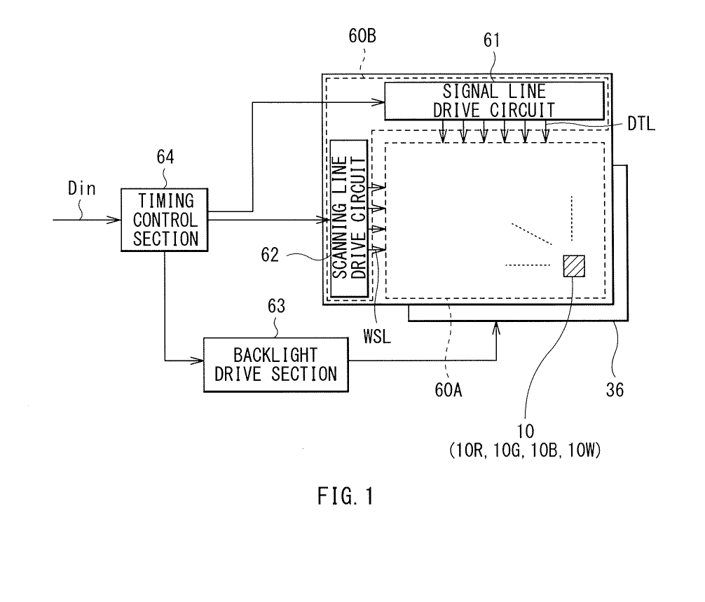

FIG. 1 illustrates an overall configuration of a display device (display device 1) according to an embodiment of the present disclosure. The display device 1 may be a liquid crystal display device, for example, and includes a pixel section 60A, a circuit section 60B, a backlight 36, a backlight drive section 63, a timing control section 64, etc. In addition to the above-described sections, an image signal processing circuit, etc. (not illustrated) that applies predetermined correction processing to an image signal may be provided, for example. Each pixel 10 is connected to a scanning line WSL and a signal line DTL. Here, the liquid crystal display device is given as an example, but the display device of the present disclosure is not limited thereto. Embodiments of the present disclosure are applicable to all types of display devices that perform color display, such as an organic EL display device.

The pixel section 60A includes a plurality of pixels (pixel) 10 that may be two-dimensionally arranged in a form of matrix, for example. Each pixel 10 may include pixels 10R, 10G, 10B, and 10W (sub-pixels), for example. A configuration of these pixels 10R, 10G, 10B, and 10W will be described later.

The circuit section 60B may include a scanning line drive circuit 62 and a signal line drive circuit 61, for example. The scanning line drive circuit 62 line sequentially drives each of the pixels 10 in accordance with timing control through the timing control section 64. The signal line drive circuit 61 supplies to each of the pixels 10 a picture voltage based on an input image signal Din supplied from the timing control section 64. Specifically, the signal line drive circuit 61 applies a D/A (digital to analog) conversion to the input image signal Din, thereby generating an image signal being an analog signal and outputting the thus-generated image signal to each pixel.

The timing control section 64 controls drive timing of the scanning line drive circuit 62 and the signal line drive circuit 61. The timing control section 64 also supplies the input image signal Din inputted from the outside to the signal line drive circuit 61. Note that, in the present embodiment, in performing a display drive based on sub-pixel rendering to be hereinafter described, an image signal corresponding to a sub-pixel-based image display is used as the input image signal Din.

The backlight 36 is a light source for applying light to the pixel section 60A, and may include a plurality of LEDs (Light Emitting Diode) or CCFLs (Cold Cathode Fluorescent Lamp), etc., for example. The backlight 36 is driven by the backlight drive section 63 so that an ON state and an OFF state are controlled.

Here, the pixel 10 of the present embodiment corresponds to a specific but not limitative example of “pixel” of the present disclosure, and the pixels 10R, 10G, 10B, and 10W each correspond to a specific but not limitative example of “sub-pixel” of the present disclosure. Further, the circuit section 60B and the timing control section 64 correspond to a specific but not limitative example of “drive section” of the present disclosure.

(Pixel Array)

The pixel 10 configures a basic unit for display (i.e., pixel) in the display device 1. As units for color production that are different in color from one another (i.e., sub-pixels), the pixel 10 may include the pixels 10R, 10G, and 10B for light emission of respective colors of R (red), G (green), and B (blue), and the pixel 10W for light emission of W (white), for example. The pixel 10W may be a pixel (a high luminance pixel) arranged for the purpose of achieving higher luminance, for example. In this manner, in the present embodiment, each of the pixels 10 includes four sub-pixels (pixels 10R, 10G, 10B, and 10W). Among these sub-pixels, two sub-pixels (pixels 10G and 10W) each emit color light that contains a luminance component (Y) as a primary component. In other words, in spectral characteristics, the pixels 10G and 10W each have a light-emission spectrum peak near a peak wavelength of the luminance component.

In the present embodiment, these pixels 10G and 10W are disposed to have a symmetry property with respect to a center of the pixel (for example, a center of gravity in an XY planar shape of the pixel 10) in one pixel 10. That is, in the present embodiment, one pixel 10 corresponds to one specific but not limitative example of “unit region” of the present disclosure. Besides the above-described pixels 10G and 10W, examples of color that contains a large number of luminance component (Y) may include Y (yellow) and cyan. Here, as “first sub-pixel” and “second sub-pixel” of the present disclosure, the pixels 10G and 10W are given as an example. However, a pixel for emitting yellow light or cyan light may be arranged in place of one or both of the pixels 10G and 10W. Further, three or more pixels (sub-pixels) each emitting light having a wavelength that contains a large number of such luminance component may be included in one pixel (pixel).

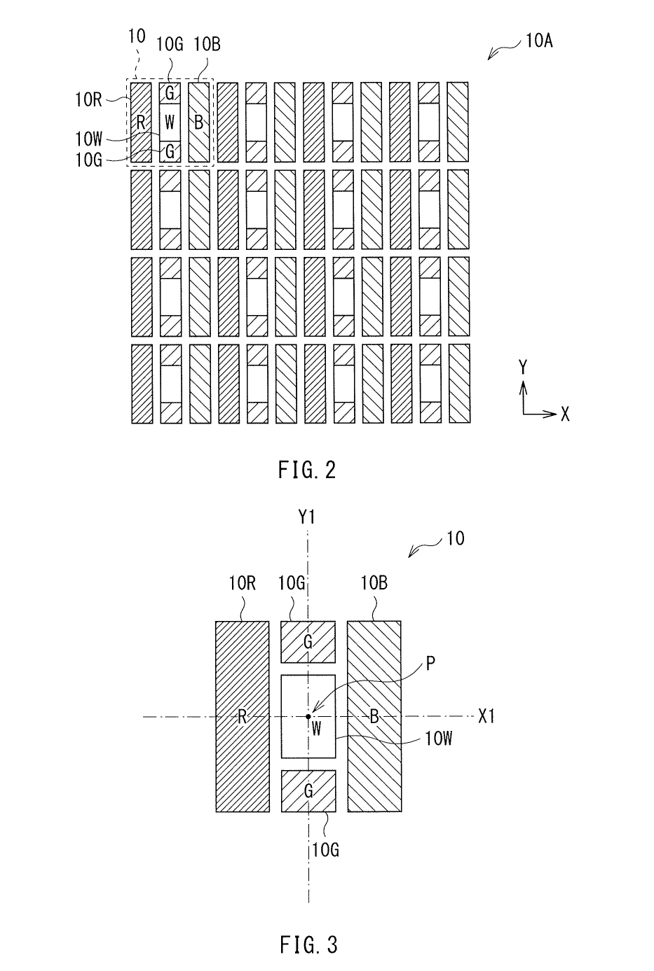

FIG. 2 schematically illustrates a configuration of a pixel array (pixel array A) according to the present embodiment. As described above, in the present embodiment, the pixels 10R, 10G, 10B, and 10W may be disposed to have a stripe shape as a whole, for example. The stripe may include a plurality of (here, three) lines (rectangular regions) that may extend in a direction (Y direction) of a pixel row, for example. Further, the pixels 10R and 10B are each arranged to form one line. In the pixel array A, the pixels 10G and 10W, for example, may be arranged side-by-side in the Y direction, thereby forming one line in the above-described stripe.

As illustrated in FIG. 3, specifically, the pixels 10G and 10W are arranged so as to be point-symmetry with respect to a pixel center P. Further, in this example, the pixels 10G and 10W are line-symmetry with respect to an axis X1 passing through the pixel center P and extending in the X direction. Also, the pixels 10G and 10W are line-symmetry with respect to an axis Y1 passing through the pixel center P and extending in the Y direction. With such symmetry property, a so-called luminance center of gravity of the pixels 10G and 10W is matched with the pixel center P. Here, in the pixel 10, the pixel 10W is arranged in a central region that includes the pixel center P, and the pixels 10G are arranged in two locations that interpose that pixel 10W therebetween. In this manner, in the pixel array A, two pixels 10G are arranged with respect to one pixel 10W in the pixel 10, thereby achieving the above-described symmetry property. However, note that positions where the pixels 10G and 10W are provided, the number of such positions, and the area thereof may be set as appropriate, depending on the priority levels of luminance and color balance, without particular limitation.

[Function and Effect]

As illustrated in FIG. 1, in the display device 1, when the input image signal Din is inputted to the timing control section 64, the scanning line drive circuit 62 and the signal line drive circuit 61 performs a display drive of each of the pixels 10 in the pixel section 10A. Specifically, in accordance with control of the timing control section 64, the scanning line drive circuit 62 sequentially supplies a scanning signal to the scanning line WSL connected to each pixel, and the signal line drive circuit 61 supplies an image signal based on the input image signal Din to the predetermined signal line DTL. Thereby, the pixel 10 located at an intersection of the signal line DTL to which the image signal is supplied and the scanning line WSL to which the scanning signal is supplied is selected, and a drive voltage is applied to that pixel 10. In the selected pixel 10, incident light from the backlight 36 is modulated in accordance with the applied drive voltage, and color tone and luminance based on an emission intensity of each of the pixels 10R, 10G, 10B, and 10W are achieved. Such display drive of the pixel 10 is performed line-sequentially, and thereby an image based on the input image signal Din is displayed.

As described above, in the present embodiment, the pixel 10 includes the pixel 10W of W in addition to three pixels 10R, 10G, and 10B of R, G, and B as sub-pixels. Accordingly, two pixels each emitting light that contains a large number of luminance components, namely, each having a high luminosity factor, are provided in one pixel 10.

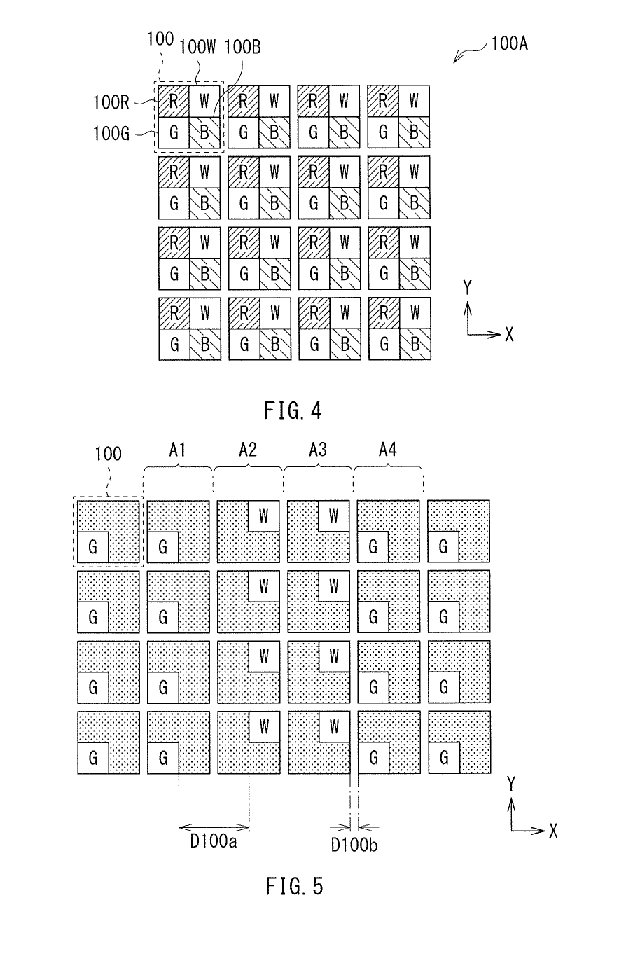

FIG. 4 illustrates a pixel array (pixel array 100A) according to a comparative example of the present embodiment. In the pixel array 100A, four sub-pixels (pixels 100R, 100G, 100B, and 100W) that emit respective color light beams of R, G, B, and W are arranged in one pixel (pixel 100) in a lattice form. That is, in the pixel 100, in each region of 2×2, any one of the pixels 100R, 100G, 100B, and 100W is arranged, and the pixels 100R, 100G, 100B, and 100W each have a planar shape of square substantially.

FIG. 5 schematically illustrates pixel columns (A1 and A4) in which the pixels 100G are driven to emit light and pixel columns (A2 and A3) in which the pixels 100W are driven to emit light in the pixel array 100A of the comparative example. Note that all sub-pixels other than the pixels 100G and 100W are indicated with black. In this manner, in the pixel array 100A, intervals (D100a and D100b) between the pixels 100G and 100W in the X direction are different depending on locations. For example, between the pixel columns A1 and A2, the interval D100a between the pixels 100G and 100W is too large, whereas between the pixel columns A3 and A4, the interval D100b between the pixels 100G and 100W is too small. In a displayed image, since the pixels 100G and 100W each have a high luminosity factor, a part corresponding to the interval D100a is viewed easily as a dark line, for example, and a part corresponding to the interval D100b is viewed easily as a bright line, for example.

In contrast, in the pixel array A of the present embodiment, among the pixels 10R, 10G, 10B, and 10W, the pixels 10G and 10W are arranged to have the symmetry property with respect to the pixel center P in the pixel 10.

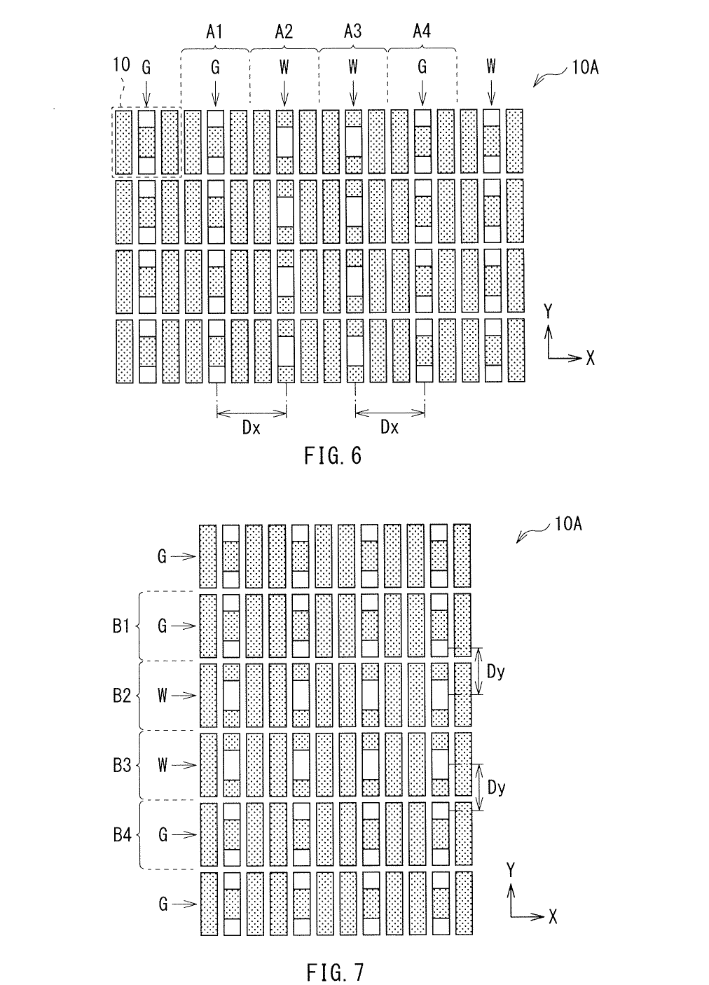

FIG. 6 schematically illustrates pixel columns (A1 and A4) in which the pixels 10G are driven to emit light and pixel columns (A2 and A3) in which the pixels 10W are driven to emit light in the pixel array 10A. In the pixel array 10A, with the symmetry property of the pixels 10G and 10W as described above, an interval (Dx) between the pixels 10G and 10W in the X direction becomes substantially constant (an interval between the pixels 10G and 10W becomes substantially constant between the pixel columns that are adjacent to each other). Accordingly, in the present embodiment, even when the pixels 10G and 10W each having a high luminosity factor are made to emit light in each of the two adjacent pixel columns, for example, generation of the above-described dark line (or bright line) is suppressed in the displayed image.

FIG. 7 schematically illustrates pixel rows (B1 and B4) in which the pixels 10G are driven to emit light and pixel rows (B2 and B3) in which the pixels 10W are driven to emit light in the pixel array 10A. In the pixel array 10A, with the symmetry property of the pixels 10G and 10W as described above, an interval (Dy) between the pixels 10G and 10W in the Y direction becomes substantially constant (an interval between the pixels 10G and 10W becomes substantially constant between the pixel rows that are adjacent to each other). Accordingly, in the present embodiment, even when the pixels 10G and 10W each having a high luminosity factor are made to emit light in each of the two adjacent pixel rows, for example, generation of the above-described dark line (or bright line) is suppressed in the displayed image.

In this manner, in the present embodiment, the pixels 10G and 10W each emitting the color light that contains the luminance component as a primary component have the symmetry property with respect to the pixel center P in the pixel 10. Thereby, generation of the dark line (or the bright line) is suppressed. Further, in the pixel array 10A of the present embodiment, with the above-described configuration, both the intervals (Dx and Dy) between the pixels 10G and 10W in the X and Y directions become constant when the pixels 10G and 10W are driven to emit light. Therefore, the displayed image is achieved in which the dark line (the bright line) is suppressed in the horizontal direction and also in the vertical direction, for example.

Further, in the present embodiment, in the pixel array 10A, the pixels 10R, 10G, 10B, and 10W are disposed to form a stripe as a whole. In particular, the pixels 10G and 10W are disposed to form a single line in the Y direction while having the above-described symmetry property. In the pixel array 10A, the pixels 10R, 10G, 10B, and 10W form such a stripe, thereby achieving a pixel structure preferable for a display drive based on so-called sub-pixel rendering to be hereinafter described.

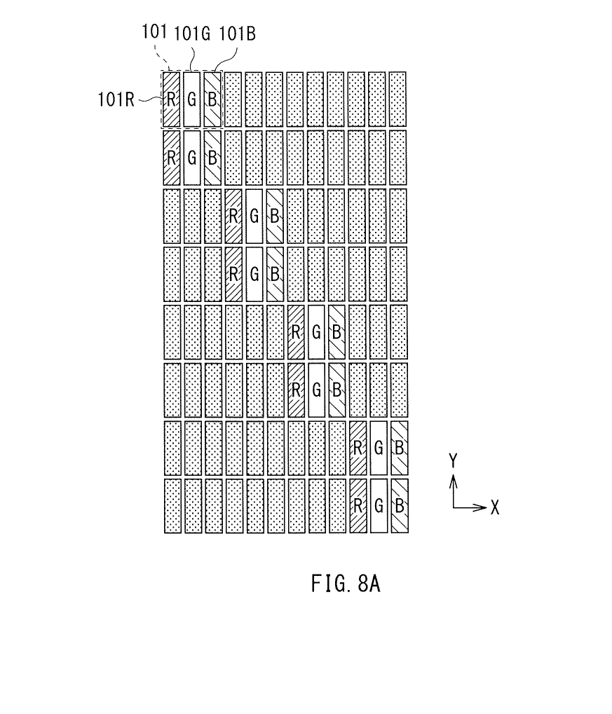

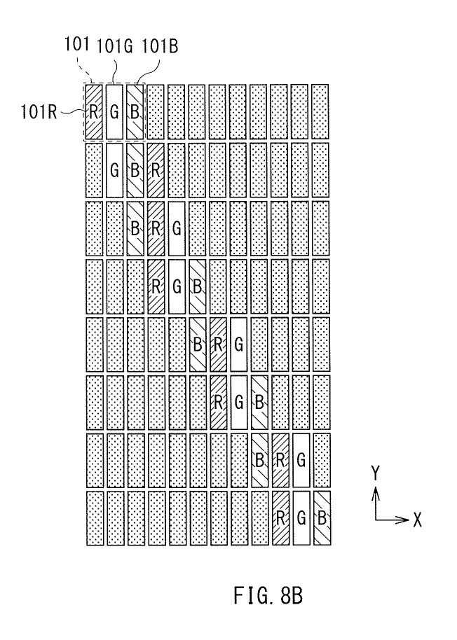

First, with reference to FIGS. 8A and 8B, an outline of a display drive operation based on the sub-pixel rendering using sub-pixels of R, G, and B is described. FIG. 8A schematically illustrates a display drive operation on a pixel basis, and FIG. 8B schematically illustrates a display drive operation on a sub-pixel basis (sub-pixel rendering), in a case where a “white line extending in an oblique direction” is to be expressed as a displayed image, for example. The sub-pixel rendering may be performed on a pixel array in which sub-pixels of R, G, and B are disposed in a stripe shape, for example, and an image signal corresponding to the sub-pixel rendering is used as the input image signal Din.

When the display drive is performed on a pixel 101 basis (on a pixel basis), pixels 101R, 101G, and 101B (sub-pixels) in the selective pixel 101 are driven to emit light as one group as illustrated in FIG. 8A, for example. White is displayed for each pixel 101 to express an oblique white line.

On the other hand, when the display drive is performed based on the sub-pixel rendering, each of the pixels 101R, 101G, and 101B is considered as a virtual unit for display, and the selective pixels 101R, 101G, and 101B are driven to emit light as illustrated in FIG. 8B, for example. That is, regardless of the group of the pixels 101R, 101G, and 101B configuring one pixel 101, respective array groups, which may be adjacent to each other in the X direction and each including a combination of the pixels 101R, 101G, and 101B, are used to display white (i.e., array groups of (R, G, B), (G, B, R), and (B, R, G)). Thereby, as compared to a case of performing the display drive on a pixel basis as illustrated in FIG. 8A, resolution is improved and an oblique white line is smoothly expressed.

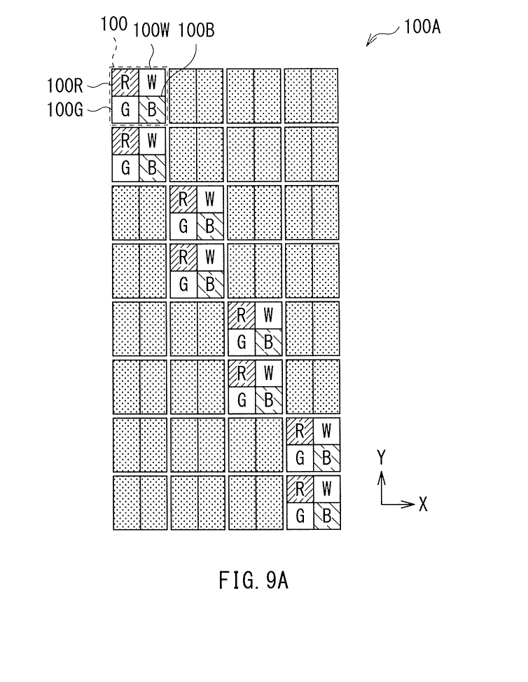

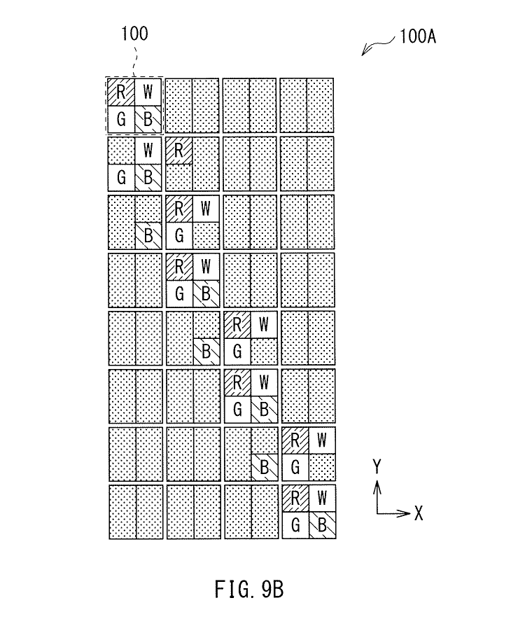

However, when such sub-pixel rendering is applied to the pixel array in which four sub-pixels including the W pixel are formed (the pixel array 100A of the comparative example), the following disadvantage occurs. When the display drive is performed on a pixel 100 basis (on a pixel basis) in the pixel array 100A, four pixels 100R, 100G, 100B, and 100W (sub-pixels) in the selective pixel 100 are driven to emit light as one group as illustrated in FIG. 9A, for example. White is displayed for each pixel 100, and an oblique white line is thereby expressed. On the other hand, as illustrated in FIG. 8B, even when each of the pixels 100R, 100G, 100B, and 100W is individually driven to emit light in the pixel array 100A by considering each of those pixels as a virtual unit for display, it is difficult to express a smooth white line in a manner of the above-described three sub-pixel configuration of R, G, and B.

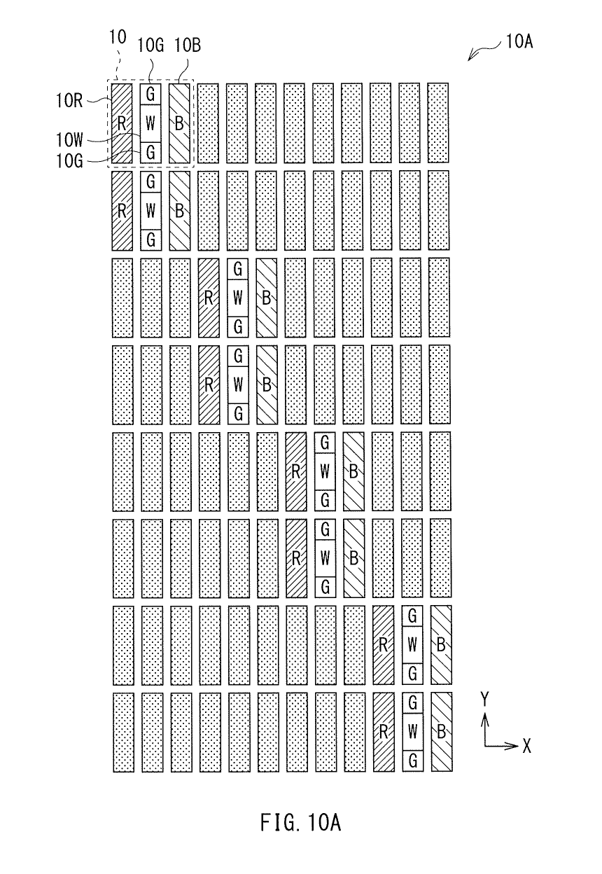

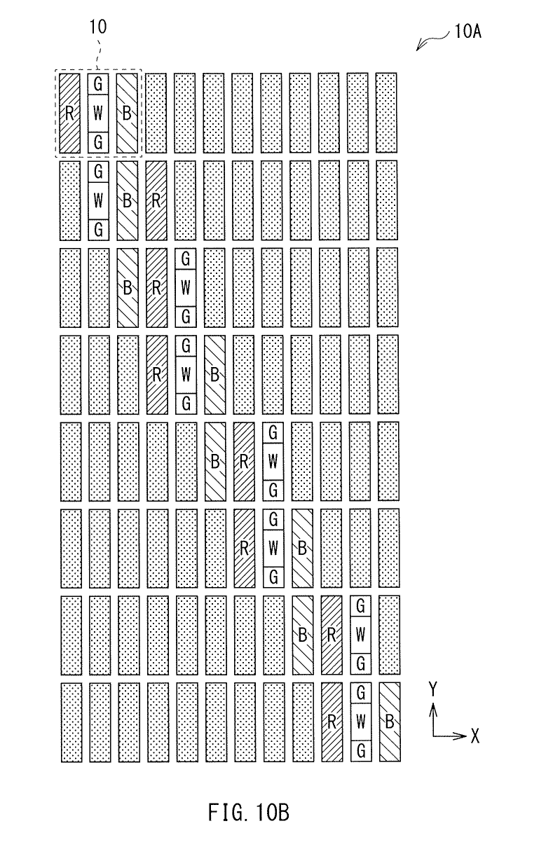

In contrast, in the pixel array 10A of the present embodiment, the pixels 10R, 10G, 10B, and 10W are disposed to form a stripe as a whole and are so disposed that the pixels 10G and 10W form a single line in the pixel 10, as described above. Hereinafter, a case where the above-described oblique white line is to be expressed in such pixel array 10A is described. FIG. 10A schematically illustrates a display drive operation performed on a pixel basis in the pixel array 10A, and FIG. 10B schematically illustrates a display drive operation performed based on the sub-pixel rendering in the pixel array 10A.

As illustrated in FIG. 10A, when performing the display drive on the pixel 10 basis (on a pixel basis), four pixels 10R, 10G, 10B, and 10W (sub-pixels) in the selective pixel 10 is driven as one group to emit light.

On the other hand, as illustrated in FIG. 10B, when performing the display drive based on the sub-pixel rendering, the pixels 10R, 10G, 10B, and 10W are driven selectively to emit light by considering each of those pixels 10R, 10G, 10B, and 10W as a virtual unit for display. In this manner, in the present embodiment, with the above-described pixel array 10A, the sub-pixel rendering in the same manner as the case of the R, G, and B (FIG. 8B) is applied to express a smooth white line. Therefore, it is possible to improve resolution and to achieve better display image quality.

As described above, in the present embodiment, among the units for color production that are different in color from one another (the pixels 10R, 10G, 10B, and 10W), the pixels that are each configured to emit the color light beam that contains the luminance component as a primary component (the pixels 10G and 10W) are disposed to have the symmetry property with respect to the pixel center P. Thereby, an interval between the pixels 10G and 10W becomes substantially constant between the pixel rows (or the pixel columns) that are adjacent to each other. As a result, for example, even when the pixel 10W is arranged in one pixel 10 for the purpose of achieving higher luminance, it is possible to suppress generation of the dark line or the bright line in a displayed image. Therefore, it is possible to suppress deterioration in display image quality while improving luminance.

Hereinafter, modification examples (modification examples 1 to 6) of the pixel array 10A of the embodiment described above are described. The same configurations and elements as those of the embodiment described above are denoted by the same reference numerals, and the description is omitted as appropriate.

### MODIFICATION EXAMPLE 1

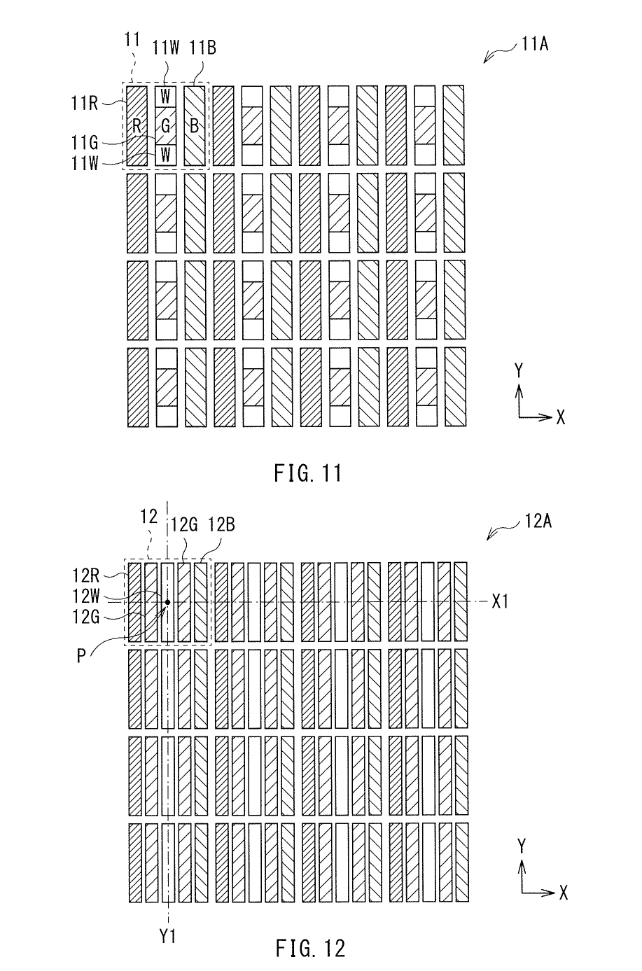

FIG. 11 schematically illustrates a configuration of a pixel array (pixel array 11A) according to modification example 1. In the pixel array 10A according to the above-described embodiment, the pixels 10G and 10W are disposed to form a single line in the stripe, and two pixels 10G are arranged with respect to one pixel 10W. However, an arrangement of these pixels 10G and 10W may be reversed. That is, in the present modification example, a pixel 11G of G may be arranged in a central region of a pixel 11 and pixels 11W of W may be arranged in two locations that interpose the pixel 11G therebetween. Even with such arrangement, since the pixels 11G and 11W have the above-described symmetry property in the pixel 11, same effects as those of the embodiment described above are achieved.

### MODIFICATION EXAMPLE 2

FIG. 12 schematically illustrates a configuration of a pixel array (pixel array 12A) according to modification example 2. In the embodiment described above, the pixels 10R, 10G, 10B, and 10W form three lines in the stripe as a whole (the pixels 10G and 10W form one line). However, one sub-pixel may form one line. That is, in the present modification example, a pixel 12 may have pixels 12R, 12G, 12B, and 12W as sub-pixels, and each of these pixels 12R, 12G, 12B, and 12W may form one line in the stripe. For example, each of the pixels 12R, 12G, 12B, and 12W may extend in the Y direction and may be arranged side-by-side in the X direction in the order of pixels 12R, 12G, 12W, 12G, and 12B. In the pixel array 12A, one pixel 12W is disposed between two pixels 12G in the pixel 12.

The same symmetry property as that of the above-described embodiment is achieved through such pixel array 12A. Specifically, the pixels 12G and 12W are disposed to be point-symmetry with respect to the pixel center P, and are disposed to be line-symmetry with respect to the axes X1 and Y1. Therefore, also in the present modification example, a luminance center of gravity of the pixels 12G and 12W is matched with the pixel center P.

Further, in the pixel array 12A, the pixels 12 are disposed to form the stripe as a whole while having the above-described symmetry property. Therefore, the pixel array 12A of the present modification example is applicable to and preferable also for the display drive based on the above-described sub-pixel rendering.

Further, in the present modification example, it is possible to form each of the pixels 12R, 12G, 12B, and 12W substantially in the same shape as one another. Accordingly, designing of a component such as a color filter is relatively easy, meaning that the present modification example is also superior in terms of productivity.

### MODIFICATION EXAMPLE 3

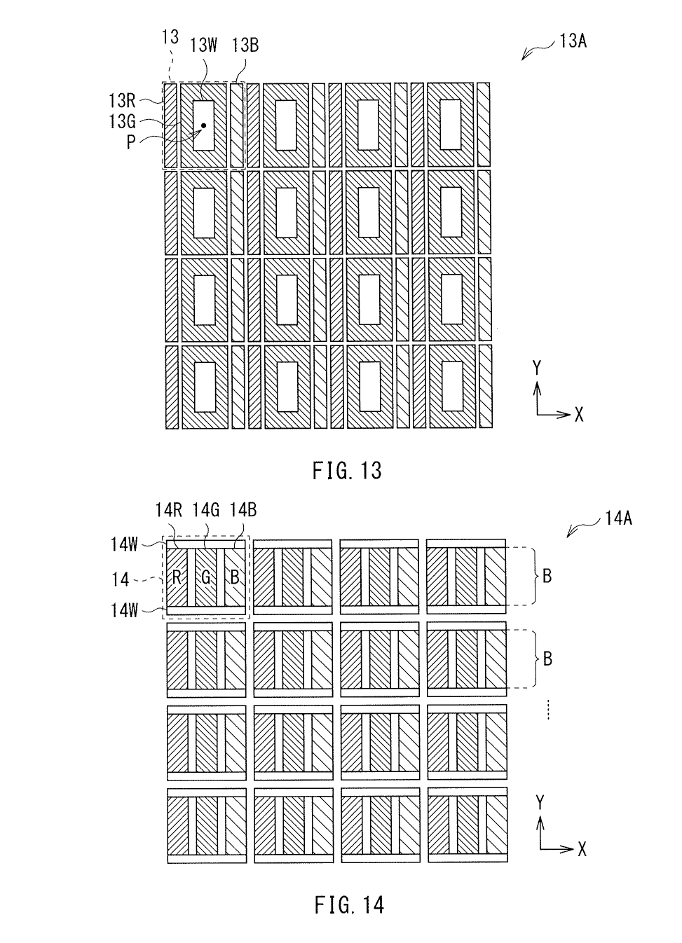

FIG. 13 schematically illustrates a configuration of a pixel array (pixel array 13A) according to modification example 3. In the embodiment described above, the pixels 10G and 10W form a line in the stripe. However, the pixels 10G and 10W do not necessarily have to have the same width as those of the R and B pixels, so long as those pixels 10G and 10W have the above-described predetermined symmetry property. In the present modification example, a pixel 13W of W may be arranged in a rectangular (or square) region between a pixel 13R of R and a pixel 13B of B in a pixel 13. Further, a pixel 13G of G may be arranged around the pixel 13W (i.e., may be arranged to surround the pixel 13W).

The same symmetry property as that of the above-described embodiment (symmetry property with respect to the pixel center P, or with respect to the axis passing through the pixel center P) is achieved by the pixel array 13A. Also, in the pixel array 13A, although a line width differs between the pixels 13R and 13B and the pixel 13G (pixel 13W), the pixels are disposed to form the stripe as a whole. Therefore, the pixel array 13A of the present modification example is applicable also to the display drive based on the above-described sub-pixel rendering.

Further, in the pixel array 13A of the present modification example, the pixel 13G is disposed to surround the pixel 13W, and the pixels 13G and 13W are disposed so as not to be separated from each other (so as to be integrated). Accordingly, for example, an image is expressed more naturally in a case of displaying a line.

### MODIFICATION EXAMPLE 4

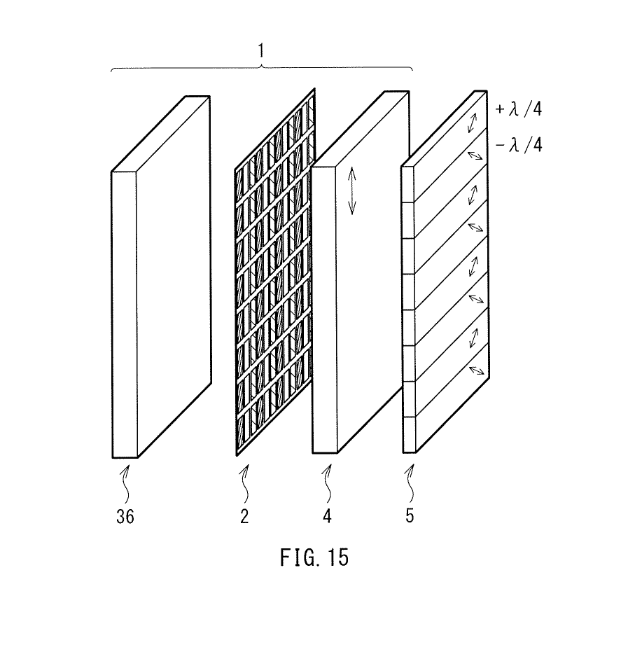

FIG. 14 schematically illustrates a configuration of a pixel array (pixel array 14A) according to modification example 4. The pixel array 14A according to the present modification example may be preferably used in performing display of a three-dimensional image, especially when performing display of a three-dimensional image on the basis a pattern retarder scheme. As illustrated in FIG. 15, for example, such display of three-dimensional image may be performed by arranging a pattern retarder 5 being a retardation film on a light emission side of the display device 1. In FIG. 15, the backlight 36, a display panel 2 having the pixel array 14A, and a polarizing plate 4 are illustrated as the display device 1. The pattern retarder 5 is a film for changing a polarization direction of incident light ray for each scanning line (for each pixel row), and in which layers having different retardations from one another are alternately arranged.

In the same manner as the embodiment described above, the pixel array 14A has a pixel 14W of W together with three pixels 14R, 14G, and 14B of R, G, and B in a pixel 14. However, in the present modification example, among these pixels, the pixels 14R, 14G, and 14B may form the stripe, and the pixels 14W may be disposed to extend in the X direction (disposed in rectangular regions in which a longitudinal direction thereof is the X direction) near boundaries (an upper part and a lower part of the pixel 14) between the adjacent pixel rows B.

The same symmetry property as that of the above-described embodiment (the symmetry property with respect to the pixel center P, or with respect to the axis passing through the pixel center P) is achieved by such pixel array 14A. Further, in the pixel array 14A, the pixels 14R, 14G, and 14B are disposed to form the stripe as a whole. Therefore, the display drive based on the above-described sub-pixel rendering is possible at the time of displaying a two-dimensional image in the pixel array 14A.

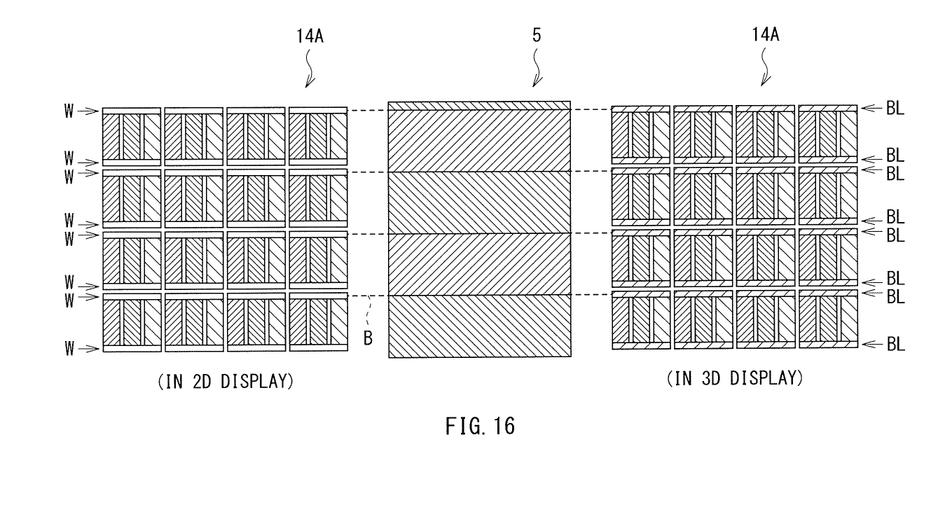

Further, the pixel array 14A of the present modification example is effective in performing a drive for displaying a three-dimensional image, especially the image of the three-dimensional display based the pattern retarder scheme, and a two-dimensional image by switching over between such a three-dimensional image and the two-dimensional image. For example, as illustrated in FIG. 16, when displaying a two-dimensional image (in 2D display), the pixels 14W may be driven to emit light (white is displayed) in each of the pixels 14 to achieve an improvement in luminance of a displayed image.

On the other hand, in displaying a three-dimensional image (in 3D display), the following effect is achieved by turning off the pixels 14W (to cause the pixels 14W to display black) in each of the pixels 14. That is, in performing a three-dimensional display based on the pattern retarder scheme, first, drive that allows an image for a right eye and an image for a left eye to be alternately displayed is performed for each pixel row B in the pixel array 14A. Here, the right-eye image and the left-eye image are those having a parallax therebetween. The pattern retarder 5 applies retardations that are different from each other to respective image light beams that correspond to the respective right-eye and left-eye images. With the use of predetermined polarization glasses, a viewer recognizes the left-eye image outputted from the pattern retarder 5 with his/her left eye, and recognizes the right-eye image outputted from the pattern retarder 5 with his/her right eye, thereby achieving a stereoscopic vision.

However, when performing a three-dimensional display based on such pattern retarder scheme, the pixel row B for displaying the right-eye image and the pixel row B for displaying the left-eye image are adjacent to each other in the pixel array 14A. Therefore, the left-eye image and the right-eye image, especially those that are outputted from the vicinity of a boundary between the pixel rows B, may cause crosstalk from the output up to the polarization and separation by the pattern retarder 5. Accordingly, the pixels 14W are displayed in black at the time of performing the three-dimensional display to block light in the vicinity of the boundary between the pixel rows B, thereby suppressing the crosstalk of the left-eye image and the right-eye image. Also, since the pixels 14W are displayed in black, an advantage is also achieved that a color expression is hard to deteriorate at the time of performing the three-dimensional display.

### MODIFICATION EXAMPLE 5

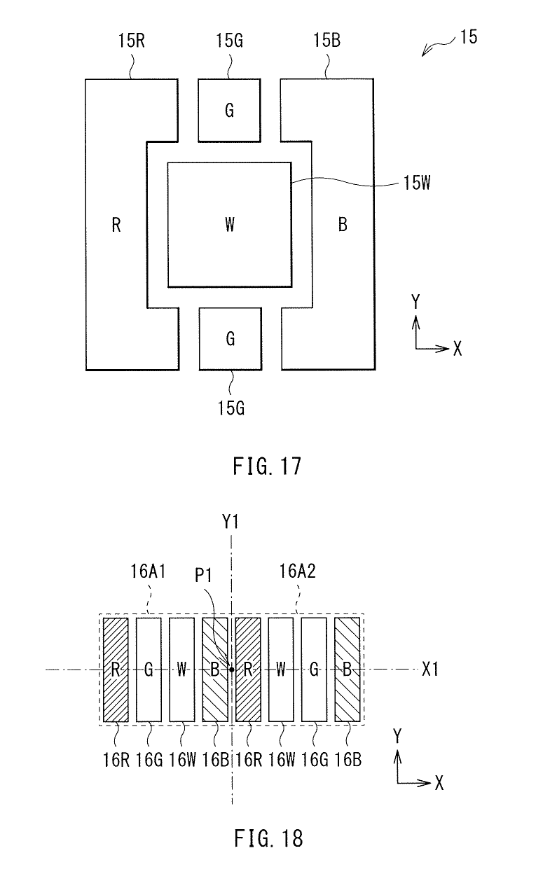

FIG. 17 schematically illustrates a configuration of each pixel in a pixel array according to modification example 5. In the above-described embodiment and modification examples, various pixel arrays (pixel arrays 10A to 14A) are given as examples; however, the arrangement of the sub-pixels of the present disclosure is not limited thereto. That is, factors such as a shape, the area, a position, etc. of each sub-pixel may be freely set, so long as the sub-pixels including the luminance component as a primary component have the above-described symmetry property. For example, in a pixel 15 illustrated in FIG. 17, a pixel 15W of W may be disposed in a central region of the pixel 15, and the other pixels 15R, 15G, and 15B may be disposed around the pixel 15W (disposed to surround the pixel 15W). Also in this example, two pixels 15G are disposed to interpose one pixel 15W in between, thereby achieving the above-described symmetry property.

### MODIFICATION EXAMPLE 6

FIG. 18 schematically illustrates a configuration of a pixel array (pixel array 16A) according to modification example 6. In the above-described embodiment and modification examples of the present disclosure, a case where the “unit region” is formed by one pixel is given as an example. However, the above-described symmetry property may be provided for a unit region that includes two or more pixels. That is, in the present modification example, a region formed by two pixels 16A1 and 16A2 that are adjacent to each other may be defined as a unit region, and the symmetry property may be provided with respect to the center P1 of the pixels 16A1 and 16A2.

Specifically, the pixels 16A1 and 16A2 each have pixels 16R, 16G, 16W, and 16B as sub-pixels. Among these pixels, the pixels 16G and 16W are disposed to be point-symmetry with respect to the center P1, and disposed to be line-symmetry with respect to the axes X1 and Y1. In the present modification example, such configuration allows a luminance center of gravity of the pixels 16G and 16W to be matched with the center P1.

In this manner, effects similar to those of the above-described embodiment are achieved by the presence of the symmetry property that may be, for example, provided between the pixels that are adjacent to each other, even if the symmetry property is not provided in one pixel.

### APPLICATION EXAMPLES

Hereinafter, some application examples of the display device described in the above-described embodiment and modification examples are described. The display device 1 of any of the above-described embodiment and modification examples is applicable to a display device of an electronic apparatus in any field, such as a smartphone, a television set, a digital camera, a notebook personal computer, a portable terminal device including a mobile phone, or a video camera. In other words, the display device 1 of any of the above-described embodiment and modification examples is applicable to a display device of an electronic apparatus, in any field, that configured to display a picture signal inputted from outside or a picture signal generated therein as an image or a picture.

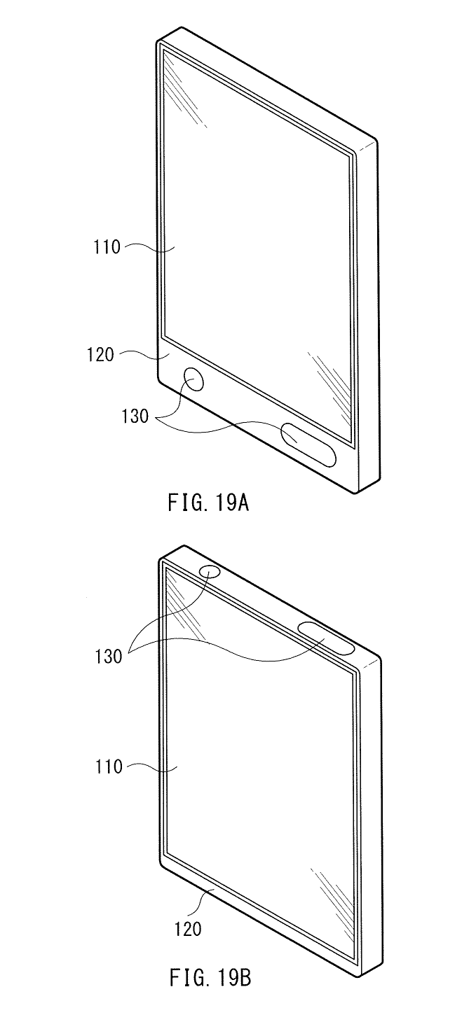

FIGS. 19A and 19B illustrate an appearance of a smartphone. The smartphone may include a display section 110 (display device 1), a non-display section (housing) 120, and an operation section 130, for example. The operation section 130 may be provided on a front surface of the non-display section 120 (FIG. 19A), or on an upper surface thereof (FIG. 19B).

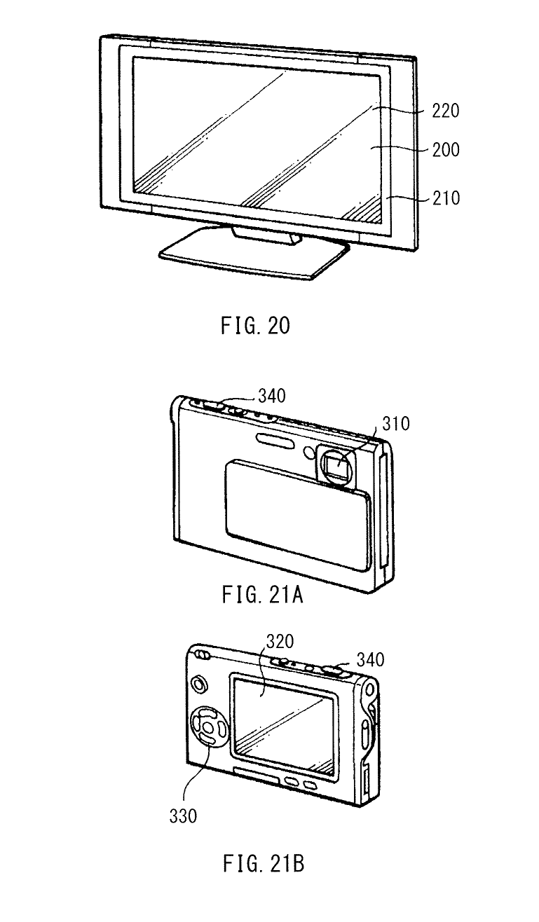

FIG. 20 illustrates an appearance configuration of a television set. The television set may include a picture display screen section 200 (display device 1) including a front panel 210 and a filter glass 220, for example.

FIGS. 21A and 21B illustrate an appearance configuration of a digital still camera, in which FIG. 21A illustrates a configuration of a front surface side thereof, and FIG. 21B illustrates a configuration of a back surface side thereof. The digital still camera may include a light-emitting section 310 for a flash, a display section 320 (display device 1), a menu switch 330, and a shutter button 340, for example.

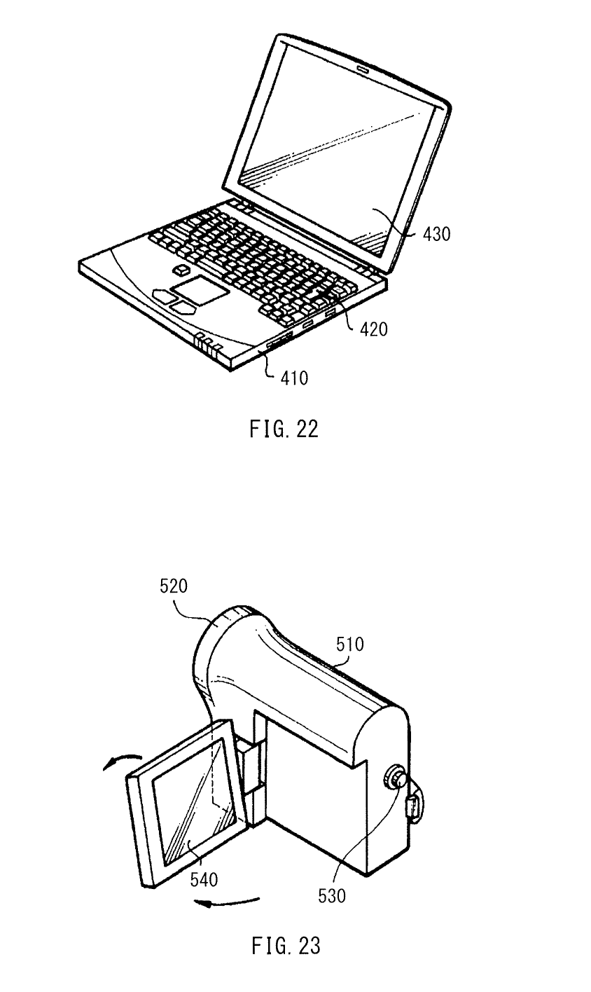

FIG. 22 illustrates an appearance configuration of a notebook personal computer. The notebook personal computer may include a main body 410, a keyboard 420 for operation of inputting characters, etc., and a display section 430 (display device 1) for displaying an image, for example.

FIG. 23 illustrates an appearance configuration of a video camera. The video camera may include a main body section 510, a lens 520 disposed on a front surface of the main body section 510 and for photographing an object, a shooting start/stop switch 530, and a display section 540 (display device 1), for example.

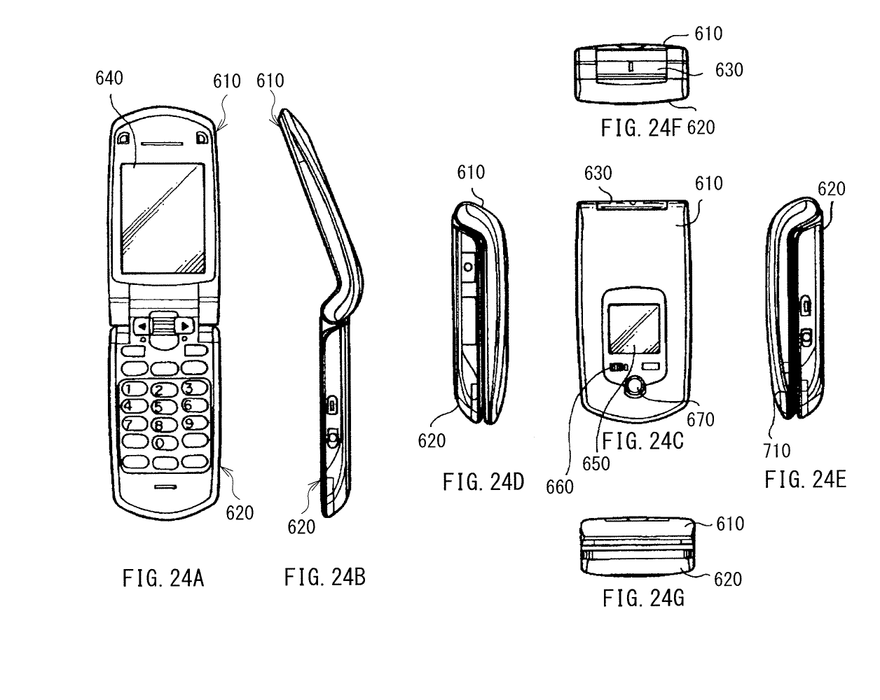

FIGS. 24A to 24G illustrate an appearance configuration of a mobile phone. The mobile phone has a configuration in which a top-side housing 610 and a bottom-side housing 620 are coupled to each other through a connection section (hinge section) 630. The mobile phone may include a display 640 (display device 1), a sub-display 650, a picture light 660, and a camera 670, for example.

Although the present disclosure is described with reference to the example embodiment and the modification examples, the present disclosure is not limited thereto, and may be variously modified. For example, in the above-described embodiment and modification examples, the liquid crystal display device is given as an example of the display device, but the present disclosure is applicable also to other types of display devices. For example, the present disclosure is applicable also to a display device using a PDP (Plasma Display Panel) or an organic EL display.

Furthermore, the technology encompasses any possible combination of some or all of the various embodiments described herein and incorporated herein.

It is possible to achieve at least the following configurations from the above-described example embodiments of the disclosure.
(1) A display device, including:

a plurality of pixels that are two-dimensionally arranged, and each including two or more sub-pixels configured to emit respective color light beams that are different in color from one another; and

a drive section configured to perform a display drive of the pixels,

the two or more sub-pixels including a first sub-pixel and a second sub-pixel each configured to emit the color light beam that contains a luminance component as a primary component, and the first sub-pixel and the second sub-pixel being disposed to have a symmetry property with respect to a center of a unit region that is formed by one or more pixels of the pixels, or with respect to an axis that passes through the center.
(2) The display device according to (1), wherein the unit region includes one pixel, and the first sub-pixel and the second sub-pixel have the symmetry property in the one pixel.
(3) The display device according to (1) or (2), wherein the two or more sub-pixels are disposed to form a stripe as a whole.
(4) The display device according to (3), wherein the drive section performs sub-pixel rendering with use of a predetermined image signal upon performing the display drive.
(5) The display device according to (3), wherein the first sub-pixel and the second sub-pixel are disposed side-by-side in a direction in which the stripe extends, and form a single line in the stripe.
(6) The display device according to (3), wherein the first sub-pixel and the second sub-pixel form respective single lines in the stripe.
(7) The display device according to (3), wherein the first sub-pixel is disposed in a region having one of a rectangular shape and a square shape, and the second sub-pixel is disposed around the first sub-pixel.
(8) The display device according to (3), wherein one of the first sub-pixel and the second sub-pixel is disposed in a direction substantially orthogonal to a direction in which the stripe extends, and is disposed at a boundary between pixel rows that are adjacent to each other.
(9) The display device according to (8), wherein the drive section switches over between a two-dimensional image and an image for three dimensional display to display the two-dimensional image and the image for three dimensional display, and allows the image for three dimensional display to be displayed based on a pattern retarder scheme.
(10) The display device according to (1), wherein, in one pixel of the pixels, the first sub-pixel in the two or more sub-pixels is disposed in a region having one of a rectangular shape and a square shape, and remaining one or more sub-pixels in the two or more sub-pixels is disposed around the first sub-pixel.
(11) The display device according to (1), wherein the unit region is formed by two or more pixels of the pixels that are adjacent to each other, and the first sub-pixel and the second sub-pixel have the symmetry property in the unit region that includes the two or more pixels adjacent to each other.
(12) The display device according to any one of (1) to (11), wherein the first sub-pixel and the second sub-pixel each emit the color light beam having a color selected from a group of white, green, yellow, and cyan.
(13) The display device according to (12), wherein the first sub-pixel emits the color light beam of white, and the second sub-pixel emits the color light beam of green.
(14) An electronic apparatus provided with a display device, the display device including:

a plurality of pixels that are two-dimensionally arranged, and each including two or more sub-pixels configured to emit respective color light beams that are different in color from one another; and

a drive section configured to perform a display drive of the pixels,

the two or more sub-pixels including a first sub-pixel and a second sub-pixel each configured to emit the color light beam that contains a luminance component as a primary component, and the first sub-pixel and the second sub-pixel being disposed to have a symmetry property with respect to a center of a unit region that is formed by one or more pixels of the pixels, or with respect to an axis that passes through the center.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device, comprising:
a plurality of pixels that are two-dimensionally arranged, and each including two or more sub-pixels configured to emit respective color light beams that are different in color from one another; and
a drive section configured to perform a display drive of the pixels,
the two or more sub-pixels including a first sub-pixel and a second sub-pixel each configured to emit the color light beam that contains a luminance component as a primary component, and the first sub-pixel and the second sub-pixel being disposed to have a symmetry property with respect to a center of a unit region that is formed by one or more pixels of the pixels, or with respect to an axis that passes through the center.

2. The display device according to claim 1, wherein the unit region includes one pixel, and the first sub-pixel and the second sub-pixel have the symmetry property in the one pixel.

3. The display device according to claim 1, wherein the two or more sub-pixels are disposed to form a stripe as a whole.

4. The display device according to claim 3, wherein the drive section performs sub-pixel rendering with use of a predetermined image signal upon performing the display drive.

5. The display device according to claim 3, wherein the first sub-pixel and the second sub-pixel are disposed side-by-side in a direction in which the stripe extends, and form a single line in the stripe.

6. The display device according to claim 3, wherein the first sub-pixel and the second sub-pixel form respective single lines in the stripe.

7. The display device according to claim 3, wherein the first sub-pixel is disposed in a region having one of a rectangular shape and a square shape, and the second sub-pixel is disposed around the first sub-pixel.

8. The display device according to claim 3, wherein one of the first sub-pixel and the second sub-pixel is disposed in a direction substantially orthogonal to a direction in which the stripe extends, and is disposed at a boundary between pixel rows that are adjacent to each other.

9. The display device according to claim 8, wherein the drive section switches over between a two-dimensional image and an image for three dimensional display to display the two-dimensional image and the image for three dimensional display, and allows the image for three dimensional display to be displayed based on a pattern retarder scheme.

10. The display device according to claim 1, wherein, in one pixel of the pixels, the first sub-pixel in the two or more sub-pixels is disposed in a region having one of a rectangular shape and a square shape, and remaining one or more sub-pixels in the two or more sub-pixels is disposed around the first sub-pixel.

11. The display device according to claim 1, wherein the unit region is formed by two or more pixels of the pixels that are adjacent to each other, and the first sub-pixel and the second sub-pixel have the symmetry property in the unit region that includes the two or more pixels adjacent to each other.

12. The display device according to claim 1, wherein the first sub-pixel and the second sub-pixel each emit the color light beam having a color selected from a group of white, green, yellow, and cyan.

13. The display device according to claim 12, wherein the first sub-pixel emits the color light beam of white, and the second sub-pixel emits the color light beam of green.

14. An electronic apparatus provided with a display device, the display device comprising:
a plurality of pixels that are two-dimensionally arranged, and each including two or more sub-pixels configured to emit respective color light beams that are different in color from one another; and
a drive section configured to perform a display drive of the pixels,
the two or more sub-pixels including a first sub-pixel and a second sub-pixel each configured to emit the color light beam that contains a luminance component as a primary component, and the first sub-pixel and the second sub-pixel being disposed to have a symmetry property with respect to a center of a unit region that is formed by one or more pixels of the pixels, or with respect to an axis that passes through the center.
